(19) United States
(12) Patent Application Publication
(10) Pub. No.: US 2013/0249528 A1
(43) Pub. Date: Sep. 26, 2013

(54) TAP CHANGER

(71) Applicants: Matthias Biskoping, Aachen (DE); Jochen Von Bloh, Aachen (DE); Dieter Dohnal, Lappersodrf (DE); Karsten Viereck, Regensburg (DE)

(72) Inventors: Matthias Biskoping, Aachen (DE); Jochen Von Bloh, Aachen (DE); Dieter Dohnal, Lappersodrf (DE); Karsten Viereck, Regensburg (DE)

(21) Appl. No.: 13/878,701

(22) PCT Filed: Nov. 10, 2011
(86) PCT No.: PCT/EP2011/005640

§ 371 Date: May 15, 2013

(30) Foreign Application Priority Data
Dec. 17, 2010 (DE) 10 2010 054 953.3

(51) Int. Cl. H02P 13/06

(52) U.S. Cl. CPC H02P 13/06
USPC 323/343

(57) ABSTRACT

The invention relates to a tap changer for regulating voltage, comprising semiconductor switching elements on a regulating transformer having a regulating winding. The tap changer is modularly constructed, wherein each module comprises a sub-winding of the regulating winding that can be switched on or off by semiconductor switching elements.

### CROSS REFERENCE TO RELATED APPLICATIONS

This application is the US-national stage of PCT application PCT/EP2011/005640 filed 10 Nov. 2011 and claiming the priority of German patent application 102010054953.3 itself filed 17 Dec. 2010.

The invention relates to a tap changer for voltage regulation with semiconductor switching elements.

DE 22 48 166 already describes a controllable transformer with semiconductor switching elements. In that case, the secondary winding consists of a specific number of regulating winding parts that are combined into a certain number of winding groups connected in series, wherein each winding group includes two or three regulating winding parts connected in parallel. In that regard, each regulating winding part is provided with a contactless switching element. Another variant is described in this specification, in which the secondary winding of the transformer consists of a group of regulating winding parts connected in series, each regulating winding part including four contactless switching elements. The arrangement is such that the direction of the voltage at the terminals of the regulating winding part is reversible and also the entire regulating winding part can be selectably bridged over.

A further device for stepped switching of the secondary voltage of a transformer is known from DE 25 08 013. In that case as well the secondary winding is grouped into part windings, wherein semiconductor switching elements can similarly be provided for switching over.

DE 197 47 712 [U.S. Pat. No. 3,978,395] describes an arrangement of a tap changer of similar kind at a tapped transformer constructed as an autotransformer. In that case, individual winding parts that can be connected individually and independently from one another are similarly provided. Apart from fixed taps of the regulating winding, in this arrangement separate winding parts can be additionally switched to or switched on.

Various forms of embodiment of a further tap changer for uninterrupted load changeover are known from WO 95/28931 [U.S. Pat. No. 5,604,423], wherein thyristors similarly serve as switching elements. In that case, different winding parts of a tap winding as part of the secondary winding of the respective tapped transformer can be switched on or switched off by means of thyristor pairs connected in anti-parallel. In addition, proposed in this specification for realization of voltage regulation as finely stepped as possible with a limited number of winding taps present is a method that is termed ‘discrete circle modulation’ and in which the thyristors are activated in such a manner that intermediate values of the secondary voltage result.

In the solutions known from the prior art, semiconductor switching elements de facto take over the function of the mechanical selector arm in classic, mechanical tap changers. Individual winding taps of the regulating windings themselves can be switched on or switched off by means of the semiconductor switching elements. It is also possible to divide the regulating winding into part windings that can be switched on separately.

The high circuit outlay and the necessary special adaptation of the semiconductor switching elements are disadvantageous in this prior art. A further disadvantage of the prior art is that, in the event of failure of individual semiconductor switching elements, regulation or at least satisfactory regulation is no longer possible.

It is the object of the invention to indicate a tap changer with semiconductor switching elements that is of simple construction. In addition, it shall have a modular construction capable of expansion. Finally, the tap changer according to the invention shall make possible a high level of regulating reliability and accuracy even in the case of failure of individual switching elements, quasi as emergency operation.

This object is fulfilled by a tap changer with the features of the first claim. The subclaims relate to particularly advantageous developments of the invention.

The general inventive idea consists of constructing the tap changer in modular form. The individual modules of the tap changer according to the invention each comprise an electrical part winding of the regulating winding that is magnetically coupled with the regulating winding, i.e. is mounted on the respective transformer arm. They further comprise a respective bridging-over path that is parallel thereto on both sides and that respectively consists of a series connection in each instance of two semiconductor switching elements. A center tap is led between the respective serially connected semiconductor switching elements of each bridging-over path. A center tap of a first module of the tap changer according to the invention is connected with the star point or the load diverter. A center tap of the last module of the tap changer according to the invention is connected with the end of the winding of the transformer at which regulation is to be carried out. The other center tap of the first module is connected with a center tap of the second module whose other center tap is connected with a center tap of the third module whose other center tap is connected with a center top of the fourth module, etc., up to the last module.

According to the invention the electrical windings in the individual modules are differently dimensioned.

If in the first module the winding there has a specific number of turns, the electrical winding in the second module has a number of turns representing a multiple. The same applies to the windings in the further modules.

It is particularly advantageous if, when three modules are present, the individual windings in the modules are formed in the ratio 1:3:6 or 1:3:9.

If four modules are provided, it is particularly advantageous to dimension the windings thereof in the ratios 1:3:6:10.

It is possible within the scope of the invention to vary the number of individual modules that in totality form the tap changer according to the invention.

The tap changer according to the invention offers a number of advantages: Firstly, a special construction of the regulating winding, usually the primary voltage winding, of the regulating transformer is not required. The tap changer itself has a simple, modular construction and is easily adaptable to different voltage steps. Adaptation of an existing regulating transformer to changed regulating tasks and regulating ranges is thus also possible at a later date. Moreover, only a few lines to the transformer winding are required for the connection of a tap changer according to the invention; the previous conductor structure of each tap of the regulating winding to the tap changer or the switching means is eliminated. Finally, in the case of the tap changer according to the invention a redundant generation of individual sub-voltages is possible; in the case of failure—which can never be excluded in practical operation—of individual switching elements the regulation can nevertheless still substantially be continued.

The invention shall be explained in still more detail by way of example with reference to drawings, in which:

FIG. 1 shows a first form of embodiment of a tap changer according to the invention, comprising part modules,

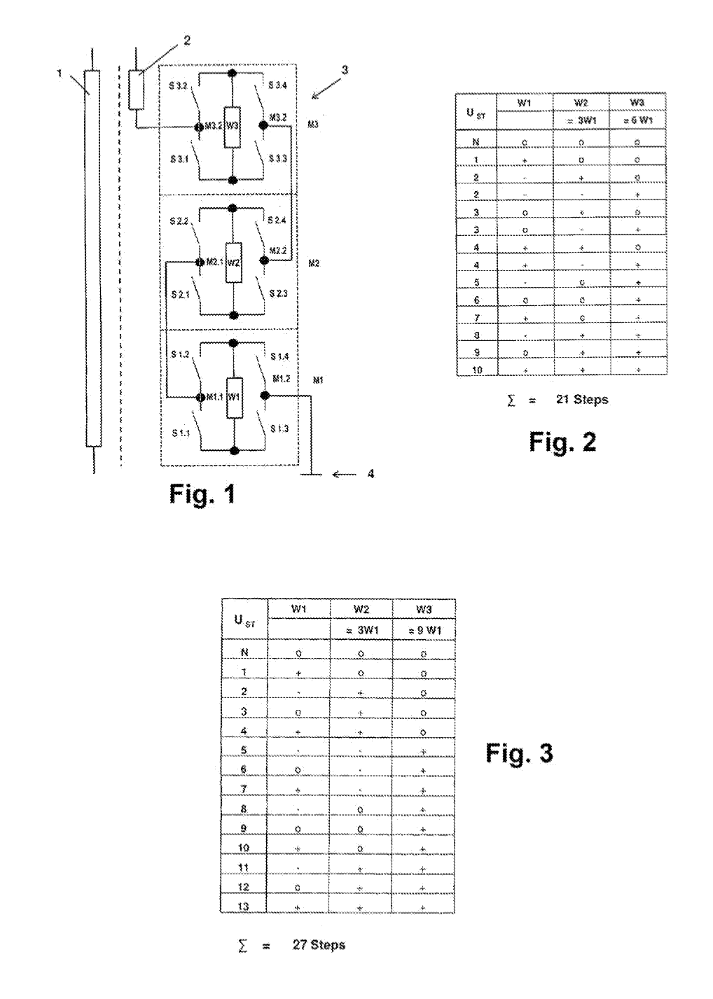

FIG. 2 shows a connection table of such a tap changer,

FIG. 3 shows a further connection table of a modified tap changer,

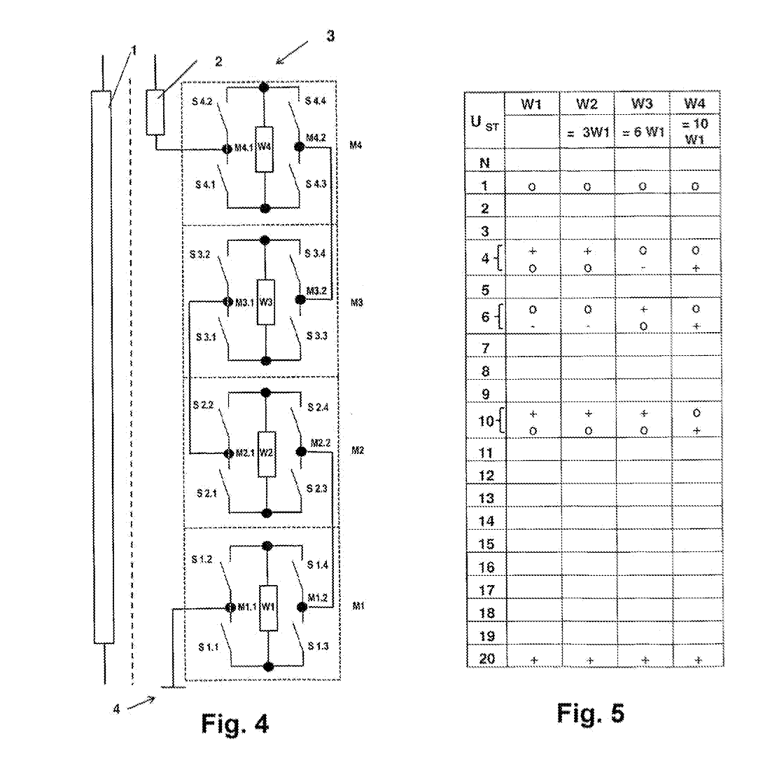

FIG. 4 shows a second embodiment of a tap changer according to the invention,

FIG. 5 shows a switching-over table of the tap changer according to FIG. 4,

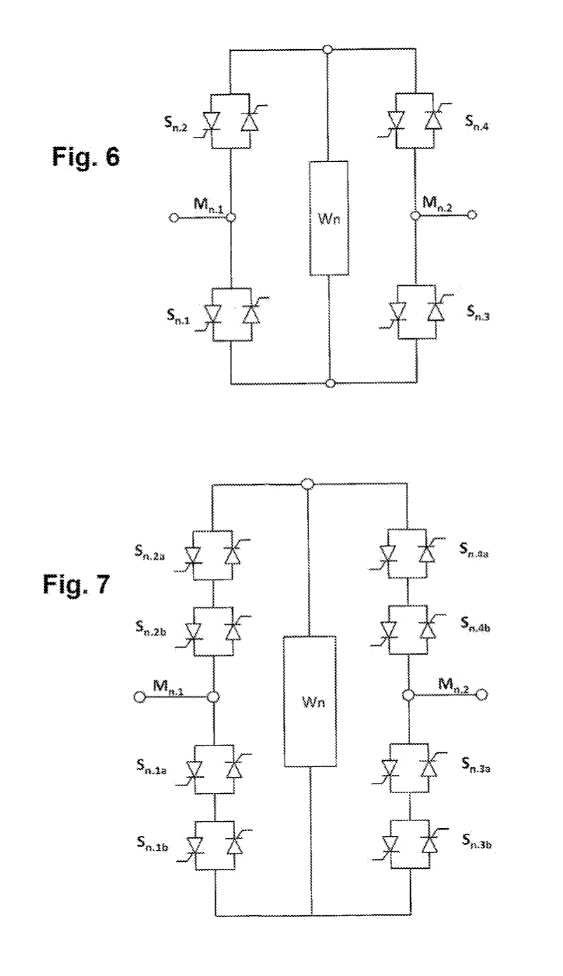

FIG. 6 shows a module of a first tap changer according to the invention by itself,

FIG. 7 shows a module of a second tap changer according to the invention by itself and

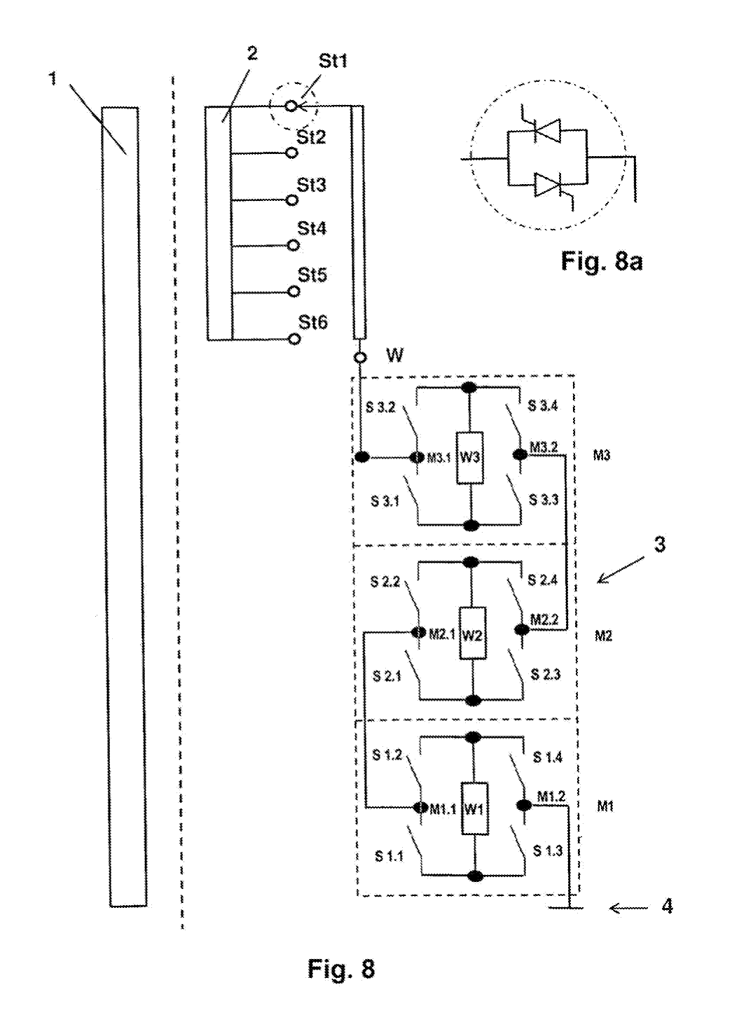

FIG. 8 shows a modified arrangement of the tap changer, which is illustrated in FIG. 1, at a regulating winding of a tapped transformer.

FIG. 1 shows a transformer that is to be regulated and that consists of a secondary voltage winding 1 and a primary voltage winding 2, with, here, three separate part windings B1 . . . B3, with which a tap changer 3 according to the invention is connected. The dotted line in that case symbolizes the scope of the tap changer 3 that here consists of three individual modules M1, M3, M3. The first module M1 comprises the first part winding W1 as well as two bridging-over paths that are on either side thereof and that each comprise a series connection of two semiconductor switching elements S1.1 and S1.2 or S1.3 and S1.4. A center tap M1.1 or M1.2 is provided in each instance between the two switching elements connected in series. The individual semiconductor switching elements are illustrated here, as also in the following figures, merely schematically as simple switches. In practice, they comprise thyristor pairs, IGBTs or other semiconductor switching elements that are connected in parallel. They can also each comprise a serial or parallel connection of several such individual semiconductor switching elements. One center tap M1.2 is electrically connected with the star point 4. The other center tap M1.1 is connected with a center tap M2.1 of a second module M2. This second module M2 is of identical construction; it similarly comprises a part winding W2 as well as the two series connections respectively of two semiconductor switching elements S2.1 and S2.2 or S2.3 and S2.4. Similarly, further center taps M2.1 and M2.2 are provided between the respective series connections. The connection of one winding tap M2.1 with the first module M1 was already explained; the second center tap M2.2 is for its part connected with a center tap M3.2 of a third module M3.

This third module M3 is in turn of identical construction. It again comprises a part winding W3 as well as the two series connections of semiconductor switching elements S3.1 and S3.2 or S3.3 and S3.4 as well as the center taps M3.1 and M3.2 disposed therebetween. The center tap M3.1, still not previously discussed, of the third and—here—last module M3 is electrically connected with the end of the primary voltage winding 2. The described—here—three modules M1 . . . M3 differ only by the dimensions of the respect part windings W1 . . . W3. The part winding W2 in the second module M2 here has three times the number of turns of the part winding W1 in the first module M1. The part winding W3 in the third module M3 here has six times the number of turns of the part winding W1 in the first module M1.

FIG. 2 shows a connection table of the tap changer according to the invention illustrated in FIG. 1. The symbol ‘0’ signifies that the corresponding part winding is not switched in, i.e. it is bridged over. The symbol ‘+’ signifies that the corresponding part winding is connected with the primary voltage winding 2 in the same sense. Finally, the symbol ‘−’ signifies that the corresponding part winding is connected with the primary voltage winding 2 in the opposite sense. Illustrated in the connection table are the ten voltage steps that result when further sub-voltages are added to the tap voltage of the primary voltage winding 2. These sub-voltages arise through the different connecting, connecting in opposition or bridging over of the individual winding parts W1 . . . W3. It can be seen that specific voltage steps are redundant, i.e. can be produced through different connection states. Similarly—but not illustrated in the table—it is possible to derive correspondingly stepped sub-voltages in the other direction from the voltage in the primary voltage winding 2. In total, in this form of embodiment twenty-one possible voltage steps therefore arise. The tap changer is without function in the center setting, here denoted by N. The end of the primary voltage winding 2 is then electrically connected directly with the star point 4. The explained connecting or connecting in opposition or bridging over of the individual winding parts W1 . . . W3 is carried out according to the invention by a corresponding connection of the semiconductor switching elements S1.1 . . . S3.4.

FIG. 3 shows a further connection table. In this case, by comparison with the just-explained form of embodiment merely the dimensioning of the part winding W3 is changed, which is now nine times the first part winding W1. In this setting a total of twenty-seven voltage steps result.

FIG. 4 shows a further form of embodiment of a tap changer according to the invention, in which there is a further module M4. The cascaded connection between the individual modules M1 . . . M4 is unchanged. The added module M4 similarly has parallel semiconductor switching elements S4.1 and S4.2 as well as S4.3 and S4.4, just as intermediate center taps M4.1 and M4.2. The center tap M4.1 is again connected with the primary voltage winding 2, whilst the center tap M4.2 is connected with the center tap M3.2 of the module M3.

FIG. 5 shows in the manner of a detail a connection table of the enlarged tap changer illustrated in FIG. 4. Not all voltage steps that arise through the corresponding connection of the individual semiconductor switches are illustrated here. Rather, it is to be shown here by way of example on the basis of the voltage steps 4, 6 and 10 that these can be created, in redundant manner, by different switching on or switching off of the individual part windings W1 . . . W4. In that case, the new part winding W4 of the module M4 is to be dimensioned in such a manner that it has ten times the number of turns of the first part winding W1 of the first module M1.

FIG. 6 shows a single module of a tap changer according to the invention. As explained, several modules n can be combined to form a tap changer according to the invention. Each module comprises a part winding Wn as well as two parallel bypass paths that each contain a series connection of two semiconductor switching elements Sn.1 and Sn.2 or Sn.3 and Sn.4. Disposed between each series connection are, as explained, center taps Mn.1 and Mn.2. The semiconductor switching elements Sn.1 Sn.4 are here illustrated as thyristors connected in anti-parallel. Other known semiconductor switching elements are also possible within the scope of the invention.

FIG. 7 shows a single module of a further tap changer according to the invention. In that case, each semiconductor switching element Sn.1 Sn.4 for its part consists of a series connection of two individual semiconductor switching elements Sn.1a, Sn.1b; Sn.2a, Sn.2b; Sn.3a, Sn.3b; Sn.4a, Sn.4b. It is also possible within the scope of the invention to provide more than two individual semiconductor switching elements respectively in series or also in parallel with one another.

FIG. 8 shows a special use of the tap changer according to the invention already explained in FIG. 1. In departure from the illustration there, here the primary voltage winding 2 has winding taps St1 . . . St6 that can be connected in conventional manner. This can be carried out not only by a tap selector that is shown only schematically, but also, as shown in the manner of a detail in FIG. 8a, by semiconductor switching elements, here, for example, an anti-parallel thyristor pair. A tap changer according to the invention, here comprising three modules M1 . . . M3, can now additionally be connected with such a conventional tap changer that directly connects winding taps. In this form of embodiment a coarse voltage regulation is thus possible by corresponding selection and connection of one of the winding taps St1 . . . St6 as well as a more finely stepped additional voltage regulation by the tap changer according to the invention.

1. A tap changer for voltage regulation with semiconductor switching elements at a regulating transformer with a regulating winding, wherein
the tap changer comprises two or more modules,
each module comprises a respective part winding of the regulating winding as well as two bridging-over paths on either side thereof,
each bridging-over path comprises a respective series connection of two semiconductor switching elements,
a center tap is provided in each instance between the two serially connected switching elements of each bridging-over path,
the part windings have different numbers of turns,
in each instance one of the two center winding taps of each module is connected with a center tap of the adjacent module, and
the one remaining center tap of the first module is connectable with the load diverter and the one remaining center tap of the last module is connectable with the regulating winding of the regulating transformer.

2. The tap changer according to claim 1, wherein exactly three modules are provided.

3. The tap changer according to claim 2, wherein the part windings of the three modules are divided up in the ratio 1:3:6 or 1:3:9.

4. The tap changer according to claim 1, wherein exactly four modules are provided.

5. The tap changer according to claim 4, wherein the part windings of the four modules are divided up in the ratio 1:3:6:10.

6. The tap changer according to claim 1, wherein the semiconductor switching elements each comprise a thyristor pair or IGBT pair connected in anti-parallel.

7. The tap changer according to claim 1, wherein at least one semiconductor switching element consists of a series connection of at least two individual semiconductor switching elements.
